(19) United States
(12) Patent Application Publication
(10) Pub. No.: US 2011/0189777 A1
(43) Pub. Date: Aug. 4, 2011

(54) METHODS AND COMPOSITIONS FOR IMPROVED DIAGNOSTIC ASSAYS

(75) Inventors: Daniel F. GRAZIANO, Wexford, PA (US); Albert D. DONNENBERG, Pittsburgh, PA (US); Thomas J. MERCOLINO, Chapel Hill, NC (US)

(73) Assignee: CYPRESS BIOSCIENCE, INC., San Diego, CA (US)

(21) Appl. No.: 12/748,060

(22) Filed: Mar. 26, 2010

Related U.S. Application Data
(63) Continuation of application No. PCT/US2008/076302, filed on Sep. 12, 2008.
(60) Provisional application No. 60/995,714, filed on Sep. 27, 2007.
(60) Provisional application No. 60/995,716, filed on Sep. 27, 2007.
(60) Provisional application No. 60/995,712, filed on Sep. 27, 2007.

(51) Int. Cl. G01N 21/00

(52) U.S. Cl. 436/10

(57) ABSTRACT

The present invention describes diagnostic calibration methods and related compositions for flow cytometry instruments using synthetic control particles as an internal reference standard. The invention provides synthetic control beads which substantially reduce the drawbacks of conventional control beads. Synthetic beads coated with C3, C4 or CR1 and a non-specific spacer protein such as ovalbumin provide a control bead without the positive reactivity seen in conventional BSA controls. The present invention further provides a buffer system containing non-specific blockers and assay performance enhancers that do not interfere with analyte detection. The invention provides advantageous improvements over prior instrument calibration procedures, and provides control beads that enable consistent, reproducible data for diagnostic assays using flow cytometry.

### CROSS REFERENCE TO RELATED APPLICATIONS

This application is a non-provisional application, which incorporates by reference herein and claims priority, in part, of U.S. Provisional Application Nos. 60/995,714, filed 27 Sep. 2007; 60/995,716, filed 27 Sep. 2007; and 60/995,712, filed 27 Sep. 2007.

### FIELD OF THE INVENTION

The present invention generally relates to improved methods and compositions for use in diagnostic assay methodologies, particularly in flow cytometry assays and related procedures. More specifically, improved instrumentation calibration methods are provided which are useful when a panel of tests are to be performed by diagnostic assay instrumentation, wherein it is necessary or desirable that low level analyte expression be discriminated between normal and abnormal patient samples and/or when it is critical to the clinical utility of the tests being performed, to have standardized test performance across instruments and laboratories. The present invention further provides improved positive control beads using ovalbumin as a spacer protein, and improved buffer compositions that are particularly useful in flow cytometry assays to balance performance and ease-of-use across a panel of clinically relevant analytes.

### BACKGROUND OF THE INVENTION

The analysis of particles, particularly biological particles and cells, is routinely performed using a variety of commercially-available instruments which determine the characteristics of such particles based on one or more light-related signals which pass through the instrument. Flow cytometry has enabled the determination of the characteristics of particles using techniques in which the particles are moving in a liquid stream or carried in a suspension. Typically in flow cytometry instruments, cells or other biological particles flow in a liquid stream so that each particle, essentially one cell at a time, passes through a sensing region that is capable of measuring the physical and chemical characteristics of the particles.

A variety of signals associated with different characteristics of the particles under analysis may be detected. Flow cytometers generally rely on optical signals for the analysis of particles which pass through the instrument. Whether or not an instrument analyzes particles in a static or a dynamic state, those skilled in the art will appreciate that calibration and standardization are required prior to performing particle analyses. Under normal circumstances, calibration occurs as one or more preliminary steps in preparing instruments for proper use and measurement and to ensure accurate and reliable assay results. This is especially important since cells, or other biological particles, are extremely small and the signals to be detected, in relation to the size of the cells or particles, are often at a low magnitude.

Flow cytometers and other biological particle and cell analysis instruments are commonly calibrated with particles which simulate or approximate the types of particles or cells that are intended to undergo analysis. Thus, calibration particles should be selected or designed so that they have characteristics and parameters that are quite similar to those of the particles or cells to be tested in the instruments. Exemplary characteristics and parameters include similarities in size, volume, surface characteristics, granularity properties, and, if necessary, color features, such as stains, dyes, immunofluorescent tags, and the like.

Calibration procedures for flow cytometry instruments, including hematology analyzers, involve the use of fixed and/or spherical red blood cells, for example, human and chicken red blood cells, for the calibration steps and for standardizing optical signals such as light scattering. See, for example, U.S. Pat. No. 4,489,162 to Hawkins, et al. and U.S. Pat. No. 4,777,139 to S.-C. Wong, et al. Microspheres or microbeads have also been used for calibrating cellular analysis instruments. For example, U.S. Pat. No. 4,331,862 to W. L. Ryan describes beads composed of latex material for calibrating a particle counting instrument. Plastic microbeads are disclosed for calibrating flow cytometers and cell analysis instruments in U.S. Pat. No. 4,704,891 to D. J. Recktenwald, et al.

In determining fluorescence, flow cytometers use polymer beads made of materials such as polystyrene to standardize the optical signals. The signals typically include forward scatter (0-2 degrees), side scatter (90 degrees) and fluorescence intensity. In addition, platelet light scattering signals are currently standardized in the case of some types of analyzers using either spherical and fixed red blood cells, for example, in commercial hematology analyzers, or using appropriately-sized polymer beads, in the case of fluorescence flow cytometers. However, the scattering signals of platelets are typically much smaller than those of red blood cells (i.e., by more than a factor of 10).

Thus, there is a present need and a′desire for standardization and calibration materials and procedures that provide accurate and reproducible results in the determination of the characteristics of both non-biological and biological particles and cells, in a variety of analysis instruments, including hematology analyzers. There is also a current need for the production of safe and stable calibration control beads for standardizing flow. cytometry instruments. Such control beads optimally need to have a long shelf-life and to have properties, such as particle size and refractive index that are virtually identical to those of the natural particles and cells which they represent during the calibration/standardization process.

To this end, previous versions of control beads in accordance with the teachings of the prior art, for use in biochemical analysis, have used non-specific proteins (for example, bovine serum albumin [BSA]) as the carrier or spacer protein on the beads. BSA, while used conventionally for this purpose, has been found to elicit a slightly higher level of fluorescence when tested (as compared to the isotype or backround control level). This is typically detected when so-called “blank” beads are made for use as a control for the bead production process. These blank beads have no specific protein (for example, no CR1, C3, or C4) attached to them, but usually go through the complete covalent coupling process, which includes an incubation step with BSA. These blank beads are known to test slightly positive with, for example, an anti-C4d antibody, indicating that there may be a small amount of contaminating C4 protein present, contained within the BSA protein reagent. Therefore BSA coated beads are not an optimal control for any assay that uses an anti-C4d antibody.

Conventional control bead technology suffers from either one or a combination of two notable drawbacks: (1) the drawback of BSA and other non-specific proteins on such beads, which contain small amounts of contaminating protein(s) which prevent them effectively from being used as reliable controls for assays; and (2) the possibility of the foregoing drawback producing inaccurate or undesirable assay results and data. Since most biochemical analysis processes require multiple steps, these drawbacks can seriously impair the usefulness of such processes.

There are numerous commercial products available that are suitable for diagnostic instrument setup and calibration, and there are positive controls available for use in conjunction with such instruments, in particular for specific flow cytometry assays. However, methods are not commercially available that incorporate both aspects, which are especially necessary for successful and accurate quantitative flow cytometry assays. One embodiment of the present invention provides for incorporation of both of these aspects.

Previous buffer compositions used in flow cytometry assays and, more specifically for use in diagnostic assay methodologies for biochemical analysis, generally contain some type of non-specific protein. Proteins frequently used for this purpose are either bovine calf serum or more specifically, bovine serum albumin. However, the present invention appreciates the interference of bovine serum proteins with the ability to accurately measure, for example, specific complement proteins using flow cytometry assays. In particular, it has been discovered that these proteins prohibit the accurate measurement of the complement component C4.

Previous flow cytometery buffer systems also are typically developed to maximize sensitivity and specificity for a particular, cell-associated analyte. This characteristic may serve to limit the usefulness of such systems.

### SUMMARY OF THE INVENTION

In contrast to the conventional methods and products for diagnostic instrument calibration, in accordance with the present invention a protocol and ancillary materials have been developed that incorporate all elements necessary for a quantitative flow cytometry assay. These elements are: a) Instrument setup/calibration; b) Internal reference standards; and c) Positive assay controls.

The control beads provided in accordance with the present invention serve to resolve the drawbacks of conventional control beads known in the art. This is accomplished by employing newly developed synthetic beads that can be used as controls, particularly suitable for use in flow cytometry assay processes. The present invention involves synthetic beads which are preferably coated with a specific protein (for example, C3, C4 or CR1), and a protein such as ovalbumin which serves as the non-specific spacer protein on the beads. The use of ovalbumin, for example, in place of BSA in the bead coating process such as used in the production of conventional control beads, unexpectedly has been found to eliminate any positive reactivity such as seen on the “blank” bead produced in accordance with conventional techniques as previously described. In addition, positive and negative control beads can be produced in accordance with the invention and are suitable to be incorporated within the sample to be analyzed, to assure binding of moieties such as monoclonal antibodies to their targets, in the presence of various other biological components found in each individual sample.

Further, the buffer system utilized in the present invention is designed to balance performance and ease-of-use across a panel of clinically relevant analytes, in contrast to known buffer systems designed to maximize sensitivity and specificity for a particular, cell-associated analyte.

Accordingly, an object of this invention is to overcome the deficiencies and inadequacies in the conventional art as described in the previous section and as generally known in the industry.

Moreover, it will be appreciated by those skilled in the art that the improved methods and compositions of the present invention, and their elements, can be used on all commercially available flow cytometers, regardless of manufacturer.

### DETAILED DESCRIPTION OF PREFERRED EMBODIMENTS OF THE INVENTION

One embodiment of the present invention, involving setup and calibration of a diagnostic instrument, is exemplified, but not limited to, the following:

Upon instrument startup and utilizing a conventional, commercially available flow cytometer instrument, beads containing the respective dye or stain, which for example may be R-phycoerythrin (R-PE) and Right Reference Standards (Bangs Laboratories, Fishers, Ind.), are run on the instrument. The PMT voltage levels are adjusted so that a specific target is achieved for level of fluorescence FL1 (green fluorescence), FL2 (orange-red fluorescence) and FL3 (red fluorescence) on the instrument. These PMT voltage settings may be used for all assays performed during a set period, such as one day. The specific target levels of fluorescence are pre-determined, based on expected levels of fluorescence for the respective assays being performed on the instrument.

The beads that are used for the initial instrument calibration as set forth above are then incorporated within each individual patient sample. In one embodiment of the present invention, two beads, representing levels of intensity (termed “framing” levels) of fluorescence expected from daily patient samples, can be added to each individual sample tube. This procedure enables the operator of the instrument to compare each individual patient sample to a reference standard, thus providing an extra measure of confidence that there is no significant instrument “drift” between patient samples that are run on the instrument.

Positive assay controls are utilized in the performance of the improved methods of the present invention, in accordance with the protocols and by using the control beads and procedures described in U.S. Patent Application 60/995,716, filed Sep. 27, 2007. Positive controls are essential for establishing that the antibody used is capable of identifying the antigen of interest. This type of control is typically prepared with an antibody associated with the target cell type. Cell lines that express the antigen of interest at high levels are good sources for positive control cells. In addition, they also give the user and operator an approximation of the intensity that positive-expressing experimental cells will have.

Conversely, negative controls are used to adjust instrument parameters so that all data appears on the scale range of the instrument. Negative controls are used for two different purposes in most situations that use fluorochrome-labeled antibodies. The first use involves a sample of cells that has not been treated with a fluorochrome-labeled antibody. This is almost always acquired as the first sample in a set because it serves as a baseline reference point. The second use typically involves setting the sensitivities of fluorescent channel PMTs so that these negative control cells appear with intensities that are near zero but still on scale. In this regard, the non-fluorescing cells establish a reference point that can be used when describing the intensity of fluorochrome-labeled cells in subsequent experimental samples. This sample also allows the user to determine the auto-fluorescence of the cells, giving a valuable reference point that establishes positively labeled cells from experimental samples with higher intensities.

The present invention contemplates positive and negative control beads, their production, and their use in the analysis of a sample. As previously stated, use of a non-specific spacer protein, which in an exemplary preferred embodiment is ovalbumin in place of BSA, in the bead coating process, unexpectedly eliminates any positive reactivity seen on the “blank” bead. One especially preferred embodiment of the invention that incorporates this observation includes the use of proteins C3, C4 and CR1. These proteins are individually and covalently coupled to polystyrene beads (Bangs Laboratories, Fishers, Ind.). The proteins are covalently coupled to activated beads using the commercially available PolyLink Protein Coupling Kit (Bangs Laboratories, Fishers, Ind.), in accordance with the manufacturer's protocol. As is commonly done with any protein coating procedure, an additional incubation step is added after the initial coupling reaction. The beads are then incubated with ovalbumin (0.2% in PBS) for 60 minutes at room temperature. The ovalbumin serves as a non-specific spacer protein that will adsorb onto any available bead surface, thus helping to stabilise the specific protein binding.

To demonstrate the advantage of using a non-specific spacer protein such as ovalbumin over the conventional techniques of the art, BSA, which is commonly used as a coating agent, was used in protein coating. Additionally, a “blank” bead was prepared in which PBS was used in place of the specific protein. These beads were then subjected to the coupling process as described above, including incubation with ovalbumin. The beads were then tested by staining with the appropriate monoclonal antibodies, followed by analysis using conventional flow cytometry techniques.

The novel use of a protein such as ovalbumin as the non-specific spacer protein for producing the control beads provided by the present invention, substantially or completely eliminates the non-specific binding observed by the anti-C4d monoclonal antibody to BSA coated beads, a typical occurrence which is problematic in the conventional art. Eliminating this “background,” particularly in fluorescence assay procedures, enables the use of beads as assay controls for procedures such as flow cytometry assays.

It is also to be appreciated by those skilled in the art that other substantially equivalent substances to ovalbumin might be utilized for the foregoing purpose, thereby in the practice of the present invention achieving the features and advantages thereof.

Examples of synthetic materials available for the choice of substrates in the control beads of the present invention are conventional plastics typically used in the art, including polystyrene, polypropylene, and others well known to those skilled in the art. Thus, the beads can generally be comprised of any type of substrate. For example, in a case where the beads are comprised of a polymer substrate, exemplary polymer substrates include polystyrene, poly(ethyl methacrylate)), poly(methyl methacrylate), polyacrylate, dextran, melamine particles crosslinked by acid catalyzed reaction with formaldehyde, polyactide, and poly(e-caprolactone). Alternatively, the beads can be comprised of glass, silica, ceramic, zirconia, titania, alumina, gold, silver, palladium or platinum. While beads are commonly spherical in shape, they are not required to be so, and can be other shapes such as rod-shaped, oblong, or irregular in shape. For spherical beads, the bead can generally have any diameter found in the art, for example suitable diameters include from about 0.05 nm to about 100 nm or greater, and ranges between these values. It is typically preferred, but not required, that the beads all have about the same size.

Additional embodiments of the present invention can comprise kits containing the bead compositions of the invention, as previously described. It will be appreciated that such kits can comprise any of the bead mixtures described in the previous section.

The control beads of the present invention are particularly well suited for assay processes using conventional commercially available equipment, enabling more accurate results to be achieved. One example of such use would be, for example, in a suitable flow cytometer analyzer for performing the biochemical reactions involved in the assay procedure that is performed on the instrument.

It is to be appreciated that various modifications may be made to the preferred embodiments of the invention as described herein, without departing from the spirit and scope, and novel teachings of the present invention, as herein described.

It should also be appreciated that this invention incorporates elements of instrument calibration and assay quality control previously not found in the conventional art. Also, the present invention does so by using commercially available components, in combination on any commercially available, conventional flow cytometry instrument platform, regardless of manufacturer. While some of these individual components may have been used previously in conjunction with flow cytometry assays, the present invention combines the features in a specific and unique manner to produce the particularly advantageous features and benefits as herein described.

The present invention further can utilize, in a preferred embodiment, an improved buffer system, suitable for use in all flow cytometer assay protocols that measure levels of analytes in body fluids such as blood, serum or saliva. In one embodiment, the improved buffer system can be used in the measurement of human complement components. It is intended that the reagent system provided by the present invention will be used as a wash buffer, and for all antibody dilutions as required in each assay protocol. It is to be appreciated that the improved buffer system is also suitable for use in re-suspending cells, prior to performing the flow cytometer analysis procedure.The buffer system utilized in the present invention can also contain blocking agents and assay performance enhancers, that do not interfere substantially with analyte detection during performance of the assay procedure, in contrast to the methodologies of the conventional art in which analytes in a clinically relevant panel typically require a variety of such blockers and enhancers to be added to the assay protocol.

In use in one embodiment of the present invention, an example of the improved buffer system comprises:
1) a blocker of general non-specific protein binding;
2) a blocker of IgG binding to B cells, as occurs on such cells in certain patient populations; and
3) buffer components to minimize platelet activation.
   All components are formulated to balance performance with ease of use in the clinical laboratory setting.

Buffers used previously in the art for flow cytometry assays typically have used bovine serum or specific components thereof (bovine serum albumin) as the non-specific protein source. These proteins have generally served their purpose without interfering with the assay. However, these proteins have proved troublesome in assays which measure complement components, specifically C4. The use of bovine proteins in such buffer systems has been known to lead to inaccurate (increased) measures of the C4 complement component. In contrast, the buffer system of the present invention, when compared to bovine serum protein containing buffers, has shown increased sensitivity in assays conducted by the present inventors which measure C4 levels, and provides a novel means of blocking IgG binding to B cells and a novel solution to the well known problem of platelet activation, by preserving the unactivated state without a fixation step.

The following examples of the practice of preferred embodiments of the present invention, are presented as illustrative, but not limitative, of the advantages that can be achieved by the invention:

### EXAMPLE 1

The following are results generated from two separate experiments in accordance with the present invention, producing data illustrating that positive control beads constructed in accordance with the invention described herein, using ovalbumin as the non-specific spacer protein, are advantageously superior to conventional beads of the prior art constructed using bovine serum albumin (BSA):

| | |
|---|---|
| BSA | Ovalbumin |

| date | MOPC | C4d | MOPC | C4d |
|---|---|---|---|---|
| 5/11 | 42.7 | 68.0 | 42.7 | 42.9 |
| 5/18 | 39.2 | 63.0 | 38.9 | 38.7 |

The values in the foregoing table represent levels of median fluorescence intensity (MFI) generated when “blank” beads are stained with either the MOPC (backround control) or the anti-C4d antibodies. “Blank” beads are defined as beads that have no specific protein (e.g., CR1, C3 or C4) covalently attached to them; simple buffer is used in place of the protein. These beads went through the entire protein coupling protocol, including the incubation with the non-specific spacer protein, in this case either BSA or ovalbumin. As is well known, a true “blank” bead, when tested using the anti-C4d antibody, should normally exhibit an MFI value close to backround levels (i.e., as seen with the MOPC antibody). The foregoing data clearly illustrate that, when tested with the anti-C4d antibody, the blank beads made using BSA as the spacer protein elicit a level of fluorescence well above that of the backround level. By comparison, the blank beads constructed with ovalbumin as the spacer protein do not elicit levels of fluorescence above backround, when tested with the anti-C4d antibody.

### EXAMPLE 2

The following data illustrates the potential utility of an embodiment of the calibration protocol of the present invention and, more specifically, how such protocol links instrument calibration at time of setup to a “real time/in sample” measurement of the same calibration standard. Taken together, these reported values enable the user to take action in one of two ways:

1. If the real time/in sample measurement falls outside a pre-established range (i.e., it is markedly different from the fluorescence level obtained at instrument setup), then the experimental value measured for that specific sample could not be accepted.

2. A correction factor could be established, and the raw mfi value for that specific sample would be multiplied by that factor and the result could be referred to as the “corrected mfi.” The correction factor would simply be the ratio of the mfi of the Right Reference Standard (“RRS) in sample, over the mfi of the RRS as determined at the time of instrument setup; see the table below.

| | | RRS: in | BC4d- | Correction | BC4d- |
|---|---|---|---|---|---|
| Sample date | RRS: setup | sample | Raw | Factor | Corrected |
| May 6, 2008 | 2226.67 | 2246.79 | 64.36 | 1.009 | 64.94 |
| May 30, 2008 | 2226.67 | 2206.73 | 376.85 | 0.991 | 373.48 |
| Apr. 25, 2008 | 2186.97 | 2226.67 | 143.3 | 1.018 | 145.9 |
| | | | EC4d- | | EC4d- |
| | | | Raw | | Corrected |
| May 6, 2008 | 2226.67 | 2206.73 | 9.65 | 0.991 | 9.56 |
| May 2, 2008 | 2206.73 | 2216.67 | 28.13 | 1.005 | 28.26 |

* All results in the foregoing table represent values of median fluorescence intensity
** It is to be appreciated that in these examples, the Right Reference Standards were run on the instrument at time of setup and also placed in the sample, and that the invention is not restricted to using these specific calibration beads but to the contrary there are many other types of beads well known to those skilled in the art that may, in practice, be substituted for these Right Reference Standards. An example would be MESF-PE beads (commercially available from Bangs Laboratories), or a bead that is specifically engineered to serve this specific function, as would be known to those of skill in the art. Such a bead, for example, might contain two levels of PE expression, while in addition also containing a dye such as allophycocyanin (APC) that could be detected by the second (red) laser contained in a conventional FACSCalibur instrument. A bead containing APC in addition to PE would also enable an increased ease of separation from the sample (i.e., the user could “gate out” the calibration beads based on their expression of APC.).

It is to be appreciated that various modifications may be made to the preferred embodiments of the invention as described herein, without departing from the spirit, scope, and novel teachings of the present invention. While certain of the preferred embodiments of the present invention have been described and specifically exemplified above, it is not intended that the invention be limited to such embodiments, and it is to be appreciated that the full scope of the improvements provided by the invention are delineated in the following claims.

What is claimed is:

1. A method for calibrating a flow cytometry instrument used in patient diagnosis comprising:
a) obtaining synthetic particles as controls having average particle diameters reproducible of particles to be assayed in a liquid flow stream essentially one cell at a time through an incident beam of light;
b) running a conventional flow cytometer instrument;
c) adjusting the PMT voltage levels to a specific target where the fluorescence levels of said target are pre-determined from expected levels of fluorescence in the assay; and
d) incorporating said synthetic particles within each individual patient sample.

2. The method according to claim 1, wherein said synthetic particles consist of two groups of intensity levels of fluorescence.

3. A synthetic control particle used in a flow cytometry instrument comprising:
a) a substrate;
b) a protein covalently coupled to said substrate; and
c) a non-specific spacer protein.

4. The synthetic control particle of claim 3 wherein said substrate is selected from the group consisting of polystyrene, poly(ethyl methacrylate), poly(methyl methacrylate), polyacrylate, dextran, and melamine wherein said substrate is formed by an acid catalyzed reaction with formaldehyde, polyactide and poly(e-caprolactone) beads.

5. The synthetic control particle of claim 3 wherein said substrate is selected from the group consisting of glass, silica, ceramic, zirconia, titania, alumina, gold, silver, palladium and platinum.

6. The synthetic control particle of claim 3 wherein said substrate is spherical.

7. The synthetic control particle of claim 3 wherein said protein is selected from a group consisting of C3, C4, CR1, and combinations thereof.

8. The synthetic control particle of claim 3 wherein said spacer protein is ovalbumin.

9. A method for the manufacture of a synthetic control beads comprising:
a) obtaining activated synthetic beads;
b) covalently coupling said beads to specific proteins;
c) incubating the product of step b); and
d) repeating step c) by incubating with a mixture comprising a non-specific spacer protein.

10. The method of claim 9 wherein said specific proteins are selected from the group consisting of C3, C4, CR1 and combinations thereof and the mixture comprises 0.2% ovalbumin in PBS.
